(19) United States
(12) Patent Application Publication
(10) Pub. No.: US 2025/0276702 A1
(43) Pub. Date: Sep. 4, 2025

(54) SELECTING A CONTROLLER FOR A VEHICLE

(71) Applicant: VOLVO TRUCK CORPORATION, Göteborg (SE)

(72) Inventors: Basar ÖZKAN, Göteborg (SE); Esteban Gelso, Västra Frölunda (SE); Maliheh Sadeghi Kati, Öjersjö (SE); Mats Jonasson, Partille (SE)

(73) Assignee: VOLVO TRUCK CORPORATION, Göteborg (SE)

(21) Appl. No.: 19/058,652

(22) Filed: Feb. 20, 2025

(30) Foreign Application Priority Data
Mar. 1, 2024 (EP) 24160988.2

(51) Int. Cl. B60W 50/00; G05D 1/644

(52) U.S. Cl. CPC B60W 50/00; G05D 1/644; B60W 2050/0013

(57) ABSTRACT

A computer system select a vehicle controller for use in control of a vehicle. The computer system has processing circuitry to acquire a plurality of input values for each of one or more input variables for simulating performance of the vehicle, wherein the plurality of input values represent an uncertainty in the respective input variable, simulate performance of the vehicle for each of a plurality of vehicle controllers, wherein a respective simulation is performed for each vehicle controller for each of a plurality of combinations of input values, determine a total cost for each vehicle controller based on the plurality of simulations performed for the respective vehicle controller, and select a vehicle controller from the plurality of vehicle controllers based on the determined costs.

### TECHNICAL FIELD

The disclosure relates generally to vehicle control. In particular aspects, the disclosure relates to selecting a controller for a vehicle. The disclosure can be applied in heavy-duty vehicles, such as trucks, buses, and construction equipment. In particular, the disclosure can be applied in multi-unit vehicle combinations with distributed propulsion and energy storage. Although the disclosure may be described with respect to a particular vehicle, the disclosure is not restricted to any particular vehicle.

### BACKGROUND

In vehicle motion management, a control system of a vehicle may determine control signals for actuators of the vehicle in order to satisfy the requested global forces of the vehicle. For example, the control system may receive an input related to a manoeuvre for the vehicle and state information of the vehicle comprising motion parameters, and determine control signals, for example in the form of propulsion, braking, steering, and/or suspension instructions, that meet the requested global forces of the vehicle subject to certain constraints, for example energy and safety constraints.

In some implementations, a vehicle control system may comprise a number of different controllers directed to different purposes. For example, it may be desired to minimise power losses, ensure vehicle stability, provide an efficient power distribution, and address many other issues. In other examples, a vehicle may be run as front wheel drive, rear wheel drive or all-wheel drive. The different controllers can be switched between dependent on current demands of the vehicle or the operator.

Selection of which controller to use at a given instant may depend on desired outcomes. In some cases, the performance of the different controllers can be predicted to inform the selection. However, uncertainties in the data used to make such predictions can lead to inaccurate or unreliable results, and therefore an inappropriate or even unsafe selection of a controller.

It is therefore desired to develop a solution for vehicle motion management that addresses or at least mitigates some of these issues.

### SUMMARY

This disclosure provides systems, methods and other approaches for selecting a vehicle controller for use in control of a vehicle. In particular, systems and methods are proposed in which a plurality of input values representing an uncertainty in an input variable are acquired for each of one or more input variables. Different combinations of the input values are used to simulate performance of the vehicle for each of a plurality of vehicle controllers. A total cost is determined for each vehicle controller based on the simulations, and a vehicle controller is selected based on the determined costs.

According to a first aspect of the disclosure, there is provided a computer system for selecting a vehicle controller for use in control of a vehicle, the computer system comprising processing circuitry configured to acquire a plurality of input values for each of one or more input variables for simulating performance of the vehicle, wherein the plurality of input values represent an uncertainty in the respective input variable, simulate performance of the vehicle for each of a plurality of vehicle controllers, wherein a respective simulation is performed for each vehicle controller for each of a plurality of combinations of input values, determine a total cost for each vehicle controller based on the plurality of simulations performed for the respective vehicle controller, and select a vehicle controller from the plurality of vehicle controllers based on the determined costs.

The first aspect of the disclosure may seek to provide a computer system that enables selection of a vehicle controller that takes uncertainties in input data into account. In particular, by simulating vehicle performance based on different combinations of input values that reflect uncertainties in input variables, a more complete understanding of possible vehicle performance is provided, and a more appropriate selection of a vehicle controller can be made.

Optionally in some examples, including in at least one preferred example, the plurality of input values for a respective input variable comprises an upper and lower bound for the input variable and/or a distribution of input values. A technical benefit may include that extreme values for an input variable are considered and therefore extreme behaviours of the vehicle can be taken into account. A technical benefit may also include that a number of relevant values for an input variable are considered and various possible behaviours of the vehicle can be taken into account.

Optionally in some examples, including in at least one preferred example, the plurality of input values are user-defined, determined based on historical data, and/or determined based on a statistical method. A technical benefit may include that different approaches to generating input values can be selected based on relevant requirements, such as availability of computational resources.

Optionally in some examples, including in at least one preferred example, the processing circuitry is configured to simulate performance of the vehicle based on a current operating point of the vehicle. A technical benefit may include that an online assessment can be performed of which controllers are appropriate, as the simulations are based on real time values relating to the vehicle.

Optionally in some examples, including in at least one preferred example, the processing circuitry is configured to simulate performance of the vehicle based on a plurality of operating points of the vehicle, and store the determined total costs in a computer storage system of the vehicle. A technical benefit may include that controller assessment for a given condition is already performed and stored, meaning that it need only be retrieved from the computer storage system, processing resources on the vehicle are saved, and any latency issues with performing simulations online are avoided.

Optionally in some examples, including in at least one preferred example, determining a total cost for a vehicle controller comprises determining a cost associated with each simulation for the respective vehicle controller, and determining a sum of the determined costs. A technical benefit may include that a complete assessment of controller suitability may be performed as all simulations of vehicle performance are taken into account.

Optionally in some examples, including in at least one preferred example, the cost associated with a simulation is determined based on one or more of longitudinal, lateral, and/or vertical acceleration and/or jerk of the vehicle, energy losses of the vehicle, a force margin to the friction limit of the tyres of the vehicle, a tyre wear value, peak power of the vehicle, deviation from a reference path, a yaw rate and/or deviation from a target yaw rate of the vehicle, a velocity and/or deviation from a target velocity of the vehicle, a roll angle of the vehicle, an articulation angle between units of the vehicle, and a pitch angle of the vehicle. A technical benefit may include that the controllers can be assessed based on one or more particular parameters of interest, which may change dependent on operating conditions of the vehicle.

Optionally in some examples, including in at least one preferred example, the processing circuitry is configured to discard any vehicle controllers having simulation results that are outside of a set of predetermined limits and/or having a cost above a predetermined value. A technical benefit may include that any controllers that results in unstable or unsafe motion are no longer considered for implementation.

Optionally in some examples, including in at least one preferred example, the plurality of vehicle controllers comprises an online vehicle controller and one or more offline vehicle controllers. A technical benefit may include that operation of controllers can be assessed based on how the vehicle is currently being controlled and possible options for upcoming control of the vehicle.

Optionally in some examples, including in at least one preferred example, the processing circuitry is configured to simulate performance of the vehicle based on one or more switching methods from the online controller to each of the one or more offline controllers. A technical benefit may include that a more complete picture of the vehicle behaviour is provided when considering switching between an online and an offline controller.

Optionally in some examples, including in at least one preferred example, the processing circuitry is configured to select the vehicle controller having the lowest total cost. A technical benefit may include that the most optimal controller at a given instant is selected to control the vehicle.

According to a second aspect of the disclosure, there is provided a vehicle comprising the computer system of the first aspect. The second aspect of the disclosure may seek to provide a vehicle capable of providing a complete understanding of possible vehicle performance and making an appropriate selection of a vehicle controller that takes uncertainties in input data into account.

According to a third aspect of the disclosure, there is provided a computer-implemented method for determining a vehicle controller for use in control of a vehicle, the method comprising acquiring, by processing circuitry of a computer system, a plurality of input values for each of one or more input variables for simulating performance of the vehicle, wherein the plurality of input values represent an uncertainty in the respective input variable, simulating, by the processing circuitry, performance of the vehicle for each of a plurality of vehicle controllers, wherein a respective simulation is performed for each vehicle controller for a plurality of possible combinations of input values, determining, by the processing circuitry, a total cost for each vehicle controller based on the plurality of simulations performed for the respective vehicle controller, and selecting, by the processing circuitry, a vehicle controller of the plurality of vehicle controllers based on the determined costs.

The third aspect of the disclosure may seek to provide a computer-implemented method that enables selection of a vehicle controller that takes uncertainties in input data into account. In particular, by simulating vehicle performance based on different combinations of input values that reflect uncertainties in input variables, a more complete understanding of possible vehicle performance is provided, and a more appropriate selection of a vehicle controller can be made.

According to a fourth aspect of the disclosure, there is provided a computer program product comprising program code for performing, when executed by processing circuitry, the computer-implemented method of the third aspect. The fourth aspect of the disclosure may seek to enable new vehicles and/or legacy vehicles to be conveniently configured, by software installation/update, to determine a vehicle controller for use in control of a vehicle in a robust manner.

According to a fifth aspect of the disclosure, there is provided a non-transitory computer-readable storage medium comprising instructions, which when executed by processing circuitry, cause the processing circuitry to perform the computer-implemented method of the third aspect. The fifth aspect of the disclosure may seek to enable new vehicles and/or legacy vehicles to be conveniently configured, by software installation/update, to determine a vehicle controller for use in control of a vehicle in a robust manner.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 schematically shows, in terms of functional blocks, a control system for a vehicle.

FIG. 2 is a flowchart of an example computer-implemented method for determining a vehicle controller for use in control of a vehicle.

FIG. 3 is a schematic diagram of an exemplary computer system for implementing examples disclosed herein, according to one example.

Like reference numerals refer to like elements throughout the description.

### DETAILED DESCRIPTION

The detailed description set forth below provides information and examples of the disclosed technology with sufficient detail to enable those skilled in the art to practice the disclosure.

A vehicle control system may comprise a number of different controllers for different purposes, which can be switched between dependent on current demands of the vehicle. Selection of which controller to use at a given instant may depend on desired outcomes. In some cases, the performance of the different controllers can be predicted to inform the selection. However, uncertainties in the data used to make such predictions can lead to inaccurate or unreliable results, and therefore an inappropriate or even unsafe selection of a controller.

To remedy this, systems and methods are proposed for selecting a vehicle controller for use in control of a vehicle. In particular, systems and methods are proposed in which a plurality of input values representing an uncertainty in an input variable are acquired for each of one or more input variables. Different combinations of the input values are used to simulate performance of the vehicle for each of a plurality of vehicle controllers. A total cost is determined for each vehicle controller based on the simulations, and a vehicle controller is selected based on the determined costs.

It will be appreciated that the methods disclosed herein can be used with any suitable form of vehicle. For example, the disclosure can be applied in vehicle combinations having a plurality of units, heavy-duty vehicles, such as trucks, buses, and construction equipment, in personal vehicles such as cars, vans, or motorbikes, or in any other suitable form of vehicle.

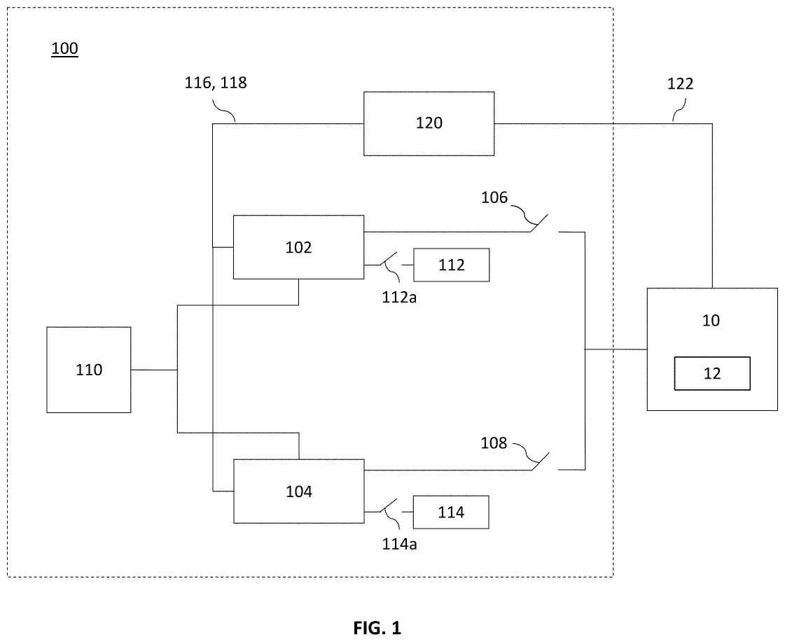

FIG. 1 schematically shows a control system 100 for a vehicle 10. The control system 100 is a computer system comprising processing circuitry configured to perform the various functions of the control system 100. In particular, the various modules may be implemented as code running on a processing circuitry, or similar. The various modules may be communicatively connected or connectable to each other, for example as known in the art.

The control system 100 may be implemented on-board the vehicle 10 or remotely from the vehicle 10.

The control system 100 comprises a number of controllers configured to control motion of the vehicle 10 in different ways. In the example of FIG. 1, the control system 100 comprises a first controller 102 and a second controller 104. The first and second controllers 102, 104 are configured to control at least one operational parameter of one or more motion support devices (MSDs) 12 of the vehicle 10. Whilst two such controllers 102, 104 are shown in FIG. 1, it will be appreciated that the control system 100 may comprise any suitable number of controllers directed to suitable number of purposes.

An MSD 12 may be any suitable actuator or subsystem of the vehicle 10. For example, an MSD 12 may be any one of an electrical machine (e.g. an electric motor), a set of service brakes, a combustion engine, a steering system (e.g. a steering system controlled by an electric motor), or a suspension system (e.g. an active or semi-active suspension system). It will be appreciated that the vehicle 10 may have any suitable number of MSDs 12 to enable operation and control of the vehicle 10. An MSD 12 may be associated with a single wheel/tyre, two or more wheels/tyres on a common axle, or any suitable number of wheels/tyres.

The first and second controllers 102, 104 are communicatively connectable to the vehicle 10 via respective switches 106, 108, such that they can control one or more operational parameters of the one or more MSDs 12. An operational parameter of the MSD 12 may be a torque or a speed of the MSD 12. The speed of an MSD 12 may be related to a wheel speed or a wheel slip, for example in the case of an electrical machine that drives one or more wheels of the vehicle 10. In some examples, one set of controllers may control a torque of one or more MSDs 12, while another set of controllers may control a speed of one or more MSDs 12. This enables operation of the MSD 12 to be controlled appropriately and for the control to be implemented in existing control interfaces.

Other examples of operational parameters that can be controlled by the first and second controllers 102, 104 include the steering angle of one or more wheels of the vehicle 10, suspension forces or suspension displacements of the vehicle 10, damping in the suspension elements, clutch engagement, gear selection, and differential lock. Controlling the steering angle provides lateral stability control, lane following, lane change, turn manoeuvers, and the like. The steering angle may be changed with an electric motor or electrohydraulic system. Controlling the suspension forces or suspension displacements enables the roll/pitch angle or height of the vehicle to be controlled. The suspension actuator can be, for example, electric, hydraulic, or pneumatic. If it is hydraulic or pneumatic, air flow or pressure may also be controlled. Controlling the damping in the suspension elements enables the ride properties to be changed. Controlling the clutch engagement enables the clutch to engage/disengage axles from each other as well as from the power source (e.g. the engine). Controlling the clutch gear selection enables control of the torque on the tires. Locking differentials is useful for off-road or construction equipment and helps stop spinning of certain tires.

The first and second controllers 102, 104 are also communicatively connected to a target generator 110 that provides a requested control input for the vehicle 10 to the controllers. The requested control input relates to a manoeuvre for the vehicle 10. The manoeuvre may be, for example, straight-line driving, cornering, braking and the like. The target generator 110 may receive a signal from, for example, a steering wheel and/or gas/brake pedal of the vehicle 10, indicating that the driver (or some other system of the vehicle 10) wants to change the direction and/or the speed of the vehicle 10 in a certain way. In some examples, the signal may originate from elsewhere, for example any other system that may provide some indication of how the overall forces of the vehicle 10 are to be influenced (e.g. steered, propelled or braked). For example, the signal may originate from a lane assist system, a lane following system, an emergency steering system, an emergency braking system, an automated or semi-automated drive system. Based on this input, and in some examples a motion capability for the vehicle 10, the target generator 110 outputs the requested control input.

In some examples, the first controller 102 may be communicatively connected to the vehicle 10 (i.e. the switch 106 is closed) and control one or more operational parameters of the one or more MSDs 12 of the vehicle 10. The first controller 102 may therefore be referred to as the “online” controller in these examples. The second controller 104 is then referred to as the “offline” controller (i.e. the switch 108 is open). Alternatively, the second controller 104 may be communicatively connected to the vehicle 10 (i.e. the switch 108 is closed) and control one or more operational parameters of the one or more MSDs 12 of the vehicle 10. The second controller 104 may therefore be referred to as the “online” controller. The first controller 102 is then referred to as the “offline” controller (i.e. the switch 106 is open).

In some examples, the first and second controllers 102, 104 are also communicatively connected to respective first and second vehicle models 112, 114. For example, the first and second controllers 102, 104 may be communicatively connected to the first and second vehicle models 112, 114 via respective switches 112a, 114a. The first and second vehicle models 112, 114 may be any suitable vehicle models known in the art. The first and second vehicle models 112, 114 may be used to model and/or predict motion of the vehicle 10, including values for the operational parameters of the MSDs 12. In this way, offline controllers can model motion of the vehicle 10 while it is being controlled by an online controller. In particular, the first and second vehicle models 112, 114 may be used to model and/or predict the vehicle velocity, tyre forces, a torque of one or more electric motors, an angular velocity of one or more electric motors, a twist angle of the shaft of one or more electric motors, and/or an angular velocity of one or more wheels, along with any other suitable variables for motion of the vehicle 10. The motion of the vehicle 10 may be longitudinal, lateral, vertical and/or rotational (about any axis: yaw, roll and/or pitch) motion. In the case of a vehicle combination, the vehicle models 112, 114 may be used to model motion of the individual units and/or the vehicle combination as a whole. The first and second vehicle models 112, 114 may have a prediction horizon of the order of a number of seconds.

The first and second vehicle models 112, 114 may be based on estimated states 116 and/or parameters 118 of the vehicle 10, which are received from an estimator 120. States 116 of the vehicle 10 include transient variables such as velocity, position, pressure, and the like. Parameters 118 of the vehicle 10 include values that describe the vehicle 10 and are generally constant, such as mass, tyre stiffness, tyre radius, and the like. The first and second vehicle models 112, 114 may also be based on inputs such as road inclination, air drag force and reference values for tyre forces. The first and second vehicle models 112, 114 may be constrained by parameters such as actuator limits of the vehicle 10. A vehicle model may be used when its respective controller is online, i.e. controlling the vehicle 10, or offline, i.e. not controlling the vehicle 10.

The estimator 120 may be communicatively connected to the vehicle 10 and configured to receive sensor measurements 122 from the vehicle 10. The sensor measurements 122 may come from sensors on board the vehicle 10, such as wheel speed sensors, inertial measurement units (IMUs, comprising accelerometers, gyroscopes, and magnetometers), electric machine speed sensors, global positioning systems, LIDAR sensors, radar sensors, cameras, and the like. Based on the sensor measurements 122, the estimator 120 estimates states 116 and/or parameters 118 of the vehicle 10. In some examples, the estimator 120 may be omitted, and the sensors of the vehicle 10 may be configured to perform estimation of states 116 and/or parameters 118 themselves or measure them directly.

Selection of which controller to use at a given instant may depend on desired outcomes. In some cases, the performance of the different controllers can be predicted to inform the selection. For example, a vehicle model, such as the first and second vehicle models 112, 114, may be used to simulate and/or predict the behaviour of the vehicle for a given controller, based on the estimated states 116 and/or parameters 118 of the vehicle 10 that are input the model. However, there may be uncertainties in raw data from sensors, processing of that data, and the like. Uncertainties in the estimated states 116 and/or parameters 118 can lead to inaccurate or unreliable results, and therefore an inappropriate or even unsafe selection of a controller.

There are many potential sources of uncertainty in the estimated states 116 and/or parameters 118. Many uncertainties come from sensor errors and/or modelling errors (e.g. due to simplifications, inaccurate assumptions, uncertainty in parameters, unknown disturbances, etc.). For example, most sensors have errors in their measurements (e.g. in accelerometers it is common to have a bias (fixed error) and noise in the measurement). Furthermore, tyre modelling can be challenging due to uncertainty in weather/road conditions. There is uncertainty in how slippery the road is depending on whether it is dry, wet, snowy, icy, muddy, etc. Tyre performance is also dependent on tyre wear, tyre temperature, and the like, which can also be difficult to estimate with certainty. Weight distribution in a vehicle, for example a trailer unit that carries goods, is also challenging to estimate even if suspension forces can be measured, as there are often not enough sensors to measure the exact distribution. The age of the vehicle may result in different performance of the parts of the vehicle resulting in uncertainty. Other vehicles and pedestrians also produce uncertainties in terms of vehicle manoeuvring. There is also uncertainty in the case of a human driver where decisions and actions may be unpredictable.

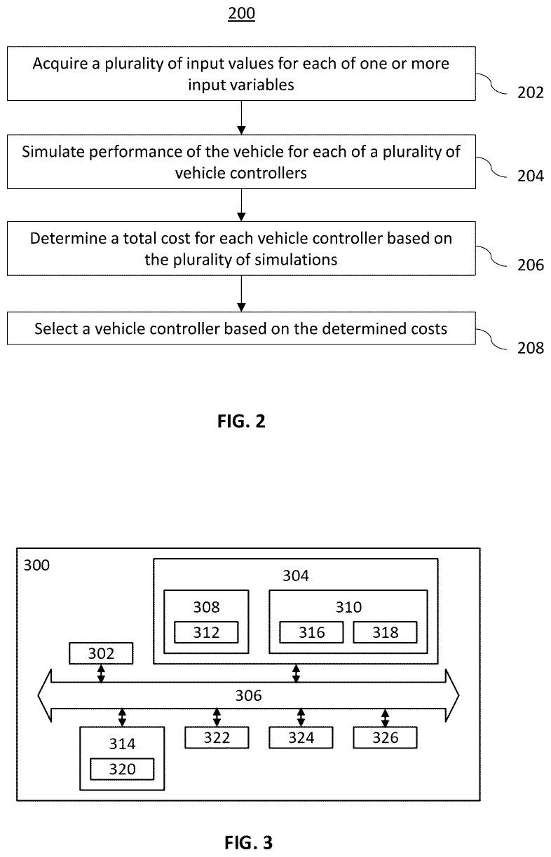

FIG. 2 is a flowchart of an example computer-implemented method 200 for determining a vehicle controller for use in control of a vehicle, such as the first and second controllers 102, 104 of the vehicle 10 illustrated in FIG. 1. The method may be implemented by processing circuitry, for example as code running on a processing circuitry, or similar. In particular, the method 200 may be implemented by the control system 100.

At 202, a plurality of input values are acquired for each of one or more input variables. An input variable is a state 116 or parameter 118 that can be used for simulating performance of the vehicle 10. As discussed above, states 116 of the vehicle 10 include transient variables such as velocity, position, pressure, and the like. Parameters 118 of the vehicle 10 include values that describe the vehicle and are generally constant, such as mass, tyre stiffness, tyre radius, and the like. Other input variables may include road inclination, air drag force and reference values for tyre forces.

The plurality of input values that are acquired for each input variables represent an uncertainty in the respective input variable. For example, the plurality of input values may be an upper and lower bound for the input variable, i.e. a maximum and minimum possible value, that cover a possible range of uncertainty. For example, for a velocity input, a maximum possible value may be 22 m/s, while a minimum possible value may be 20 m/s. This may ensure that extreme behaviours of the vehicle 10 due to extreme values of the input variable can be taken into account. The plurality of input values may also be a distribution of input values, for example a number of values spread between two upper and lower bounds. The distribution may be an even distribution between the bounds. For example, for the velocity input above, the input values may be 20 m/s, 20.5 m/s, 21 m/s, 21.5 m/s, and 22 m/s. This may ensure that a number of relevant values for an input variable are considered and various possible behaviours of the vehicle can be taken into account. Alternatively, the distribution may be a distribution that reflects the most likely values in the range (e.g. the density of the distribution may be higher in a region where the measurement is considered more reliable). For example, for the velocity input above, and given a most likely value of 21.5 m/s, the input values may be 20 m/s, 21 m/s, 21.25 m/s, 21.5 m/s, 21.75 m/s, and 22 m/s. This may ensure that the most relevant values for an input variable are considered and the most likely behaviours of the vehicle can be taken into account.

In some examples, the plurality of input values are user-defined. In some examples, the plurality of input values are determined based on historical data. In some examples, the plurality of input values are determined based on a statistical method, such as Kalman filtering. For example, linear or nonlinear filters can be used to determine the uncertainty distribution of the input values. Linear filters usually require fewer calculations whereas nonlinear filters require heavier computation loads. A commonly used linear filter is the linear Kalman filter. Nonlinear Kalman filters include extended Kalman filters, unscented Kalman filters and particle filters where the filters are listed in increasing computational load. One method is to determine the standard deviation using one of these methods, then randomly choose inputs assuming a normal distribution with this standard deviation around the most likely estimate. The more randomly inputs are chosen for simulation purposes, the more simulations must be performed, resulting in higher calculation load but a more robust set of results. It is also possible to choose two inputs (one to be a standard deviation below and the other to be a standard deviation above the most likely estimate).

At 204, performance of the vehicle 10 is simulated for each of a plurality of vehicle controllers. For example, in the context of FIG. 1, performance of the vehicle 10 is simulated for the first and second controllers 102, 104. In particular, a respective simulation is performed for each vehicle controller for a plurality of possible combinations of input values. That is to say, as there are a plurality of input values for each input variables, different combinations of input values can be used to perform different simulations.

Take an example where there are two input variables v₁ and v₂ for a vehicle model 112, 114. Each of these variables has a plurality of input values representing uncertainty in that variable: v₁₁, v₁₂, and v₁₃ for v₁, and v₂₁, v₂₂, and v₂₃ for v₂. The vehicle model 112, 114 can perform simulations based on a plurality of combinations of these values. In this case, there are nine possible combinations: v₁₁+v₂₁, v₁₁+v₂₂, v₁₁+v₂₃, v₁₂+v₂₁, v₁₂+v₂₂, v₁₂+v₂₃, v₁₃+v₂₁, v₁₃+v₂₂, and v₁₃+v₂₃.

In some examples, the input values may be determined based on current values of the input variables, such that the simulations are performed based on a current operating point of the vehicle 10. For example, the relevant simulations can be performed when the vehicle 10 is being controlled and it is desired to make an “online” selection of a controller. This enables an online assessment of which controllers are appropriate to be performed, as the simulations are based on real time values relating to the vehicle. In some examples, the input values may be representations of different values of the input variables, such that the simulations are performed based on a plurality of representative operating points of the vehicle 10. This may be the case when it is desired to perform a large number of simulations offline that can be stored in a computer storage system of the vehicle 10 for later retrieval. In this way, controller assessment for a given condition is already performed and stored, meaning that it need only be retrieved from the computer storage system, processing resources on the vehicle are saved, and any latency issues with performing simulations online are avoided.

As discussed in relation to FIG. 1, in some examples the first controller 102 may be online while the second controller 104 is offline. Simulations may be performed for both online and offline controllers, meaning that operation of the controllers can be assessed based on how the vehicle is currently being controlled and possible options for upcoming control of the vehicle. In some examples, simulating performance of the vehicle 10 may include simulating one or more switching methods between controllers. For example, as discussed. Simulation of the performance of the vehicle 10 for the second controller 104 may therefore include simulating different ways in which control is transferred from the first controller 102 to the second controller 104. For example, the switch may be performed instantaneously, in a phased manner, or via an intermediate controller. If there is more than one offline controller, simulation of switching methods may be performed for each of them. This means that a more complete picture of the vehicle behaviour is provided when considering switching between an online and an offline controller.

In some examples, certain vehicle controllers may be discarded or discounted from further selection based on the simulation results. For example, if a particular vehicle controller has simulation results that are outside of a set of predetermined limits, e.g. stability limits, a safe operating envelope, or the like, the controller can be deemed unsuitable for control of the vehicle at the present time, and be removed from further consideration. Alternatively or additionally, if a particular vehicle controller has simulation results that have a cost above a predetermined value, for example a threshold cost, the controller may be removed from further consideration. Determination of costs for simulations is discussed in relation to 206 below.

At 206, a total cost is determined for each vehicle controller 102, 104 based on the plurality of simulations performed for the respective vehicle controller 102, 104. That is to say, each simulation is associated with a cost that is determined based on the resulting performance. The cost may reflect different positive or negative aspects of the performance of the vehicle 10. For example, a cost associated with a simulation may be determined based on one or more of longitudinal, lateral, and/or vertical acceleration and/or jerk of the vehicle 10, energy losses of the vehicle 10, a force margin to the friction limit of the tyres of the vehicle 10, tyre wear, peak power of the vehicle 10, deviation from a reference path, a yaw rate and/or deviation from a target yaw rate of the vehicle 10, a velocity and/or deviation from a target velocity of the vehicle 10, a roll angle of the vehicle 10, an articulation angle between units of the vehicle 10, and a pitch angle of the vehicle 10. The roll angle may be considered in order to minimize risk of vehicle roll over. If there are a combination of vehicle units, each unit might have a different roll angle. The articulation angle, for example the angle between tractor and trailer or between other consecutive units, may be considered to minimize chance of jack-knifing. In this way, the controllers can be assessed based on one or more particular parameters of interest, which may change dependent on operating conditions of the vehicle.

Determining a total cost for a vehicle controller 102, 104 may comprise determining a cost associated with each simulation for the respective vehicle controller 102, 104, and determining a sum of the determined costs. That is to say, all simulations are taken into account. In this way, a complete assessment of controller suitability may be performed. The costs for the different simulations should be expressed in a normalized fashion or have a common unit. In some examples, a weighted sum of the determined costs may be determined in order to take the importance of costs into account. For example, in certain scenarios, a certain magnitude in velocity might have a larger effect than the same magnitude in angle, meaning the simulations relating to velocity should be more heavily weighted. In another example, the cost related to being able to follow a lane may be considered more important than a cost related to comfort. In other examples, only certain costs and/or simulations may be taken into account, for example if it is desired to only consider a subset of the costs discussed above. In the offline implementation discussed above, the total costs determined for different representative operating points of the vehicle 10 may be stored in a computer storage system of the vehicle.

At 208, a vehicle controller is selected based on the determined costs. For example, a controller having the lowest cost may be selected for controlling the vehicle 10. In this way, the most optimal controller at a given instant is selected to control the vehicle 10. In some examples, any controller having a total cost below a threshold may be selected. In this way, a number of controllers can be deemed suitable for controlling the vehicle 10, and a particular one of these can then be selected based on one or more further criteria, for example to optimise energy efficiency or tyre wear.

FIG. 3 is a schematic diagram of a computer system 300 for implementing examples disclosed herein. The computer system 300 is adapted to execute instructions from a computer-readable medium to perform these and/or any of the functions or processing described herein. The computer system 300 may be connected (e.g., networked) to other machines in a LAN, an intranet, an extranet, or the Internet. While only a single device is illustrated, the computer system 300 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 300 may comprise at least one computing device or electronic device capable of including firmware, hardware, and/or executing software instructions to implement the functionality described herein. The computer system 300 may include processing circuitry 302 (e.g., processing circuitry including one or more processor devices or control units), a memory 304, and a system bus 306. The computer system 300 may include at least one computing device having the processing circuitry 302. The system bus 306 provides an interface for system components including, but not limited to, the memory 304 and the processing circuitry 302. The processing circuitry 302 may include any number of hardware components for conducting data or signal processing or for executing computer code stored in memory 304. The processing circuitry 302 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 302 may further include computer executable code that controls operation of the programmable device.

The system bus 306 may be any of several types of bus structures that may further interconnect to a memory bus (with or without a memory controller), a peripheral bus, and/or a local bus using any of a variety of bus architectures. The memory 304 may be one or more devices for storing data and/or computer code for completing or facilitating methods described herein. The memory 304 may include database components, object code components, script components, or other types of information structure for supporting the various activities herein. Any distributed or local memory device may be utilized with the systems and methods of this description. The memory 304 may be communicably connected to the processing circuitry 302 (e.g., via a circuit or any other wired, wireless, or network connection) and may include computer code for executing one or more processes described herein. The memory 304 may include non-volatile memory 308 (e.g., read-only memory (ROM), erasable programmable read-only memory (EPROM), electrically erasable programmable read-only memory (EEPROM), etc.), and volatile memory 310 (e.g., random-access memory (RAM)), or any other medium which can be used to carry or store desired program code in the form of machine-executable instructions or data structures and which can be accessed by a computer or other machine with processing circuitry 302. A basic input/output system (BIOS) 312 may be stored in the non-volatile memory 308 and can include the basic routines that help to transfer information between elements within the computer system 300.

The computer system 300 may further include or be coupled to a non-transitory computer-readable storage medium such as the storage device 314, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 314 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 314 and/or in the volatile memory 310, which may include an operating system 316 and/or one or more program modules 318. All or a portion of the examples disclosed herein may be implemented as a computer program 320 stored on a transitory or non-transitory computer-usable or computer-readable storage medium (e.g., single medium or multiple media), such as the storage device 314, which includes complex programming instructions (e.g., complex computer-readable program code) to cause the processing circuitry 302 to carry out actions described herein. Thus, the computer-readable program code of the computer program 320 can comprise software instructions for implementing the functionality of the examples described herein when executed by the processing circuitry 302. In some examples, the storage device 314 may be a computer program product (e.g., readable storage medium) storing the computer program 320 thereon, where at least a portion of a computer program 320 may be loadable (e.g., into a processor) for implementing the functionality of the examples described herein when executed by the processing circuitry 302. The processing circuitry 302 may serve as a controller or control system for the computer system 300 that is to implement the functionality described herein.

The computer system 300 may include an input device interface 322 configured to receive input and selections to be communicated to the computer system 300 when executing instructions, such as from a keyboard, mouse, touch-sensitive surface, etc. Such input devices may be connected to the processing circuitry 302 through the input device interface 322 coupled to the system bus 306 but can be connected through other interfaces, such as a parallel port, an Institute of Electrical and Electronic Engineers (IEEE) 1394 serial port, a Universal Serial Bus (USB) port, an IR interface, and the like. The computer system 300 may include an output device interface 324 configured to forward output, such as to a display, a video display unit (e.g., a liquid crystal display (LCD) or a cathode ray tube (CRT)). The computer system 300 may include a communications interface 326 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

According to certain examples, there is also disclosed:

Example 1: A computer system (100, 300) for selecting a vehicle controller (102, 104) for use in control of a vehicle (10), the computer system (100, 300) comprising processing circuitry (302) configured to: acquire a plurality of input values for each of one or more input variables (116, 118) for simulating performance of the vehicle (10), wherein the plurality of input values represent an uncertainty in the respective input variable (116, 118); simulate performance of the vehicle (10) for each of a plurality of vehicle controllers (102, 104), wherein a respective simulation is performed for each vehicle controller (102, 104) for each of a plurality of combinations of input values; determine a total cost for each vehicle controller (102, 104) based on the plurality of simulations performed for the respective vehicle controller (102, 104); and select a vehicle controller (102, 104) from the plurality of vehicle controllers (102, 104) based on the determined costs.

Example 2: The computer system (100, 300) of example 1, wherein the plurality of input values for a respective input variable (116, 118) comprises an upper and lower bound for the input variable (116, 118) and/or a distribution of input values.

Example 3: The computer system (100, 300) of example 1 or 2, wherein the plurality of input values are user-defined, determined based on historical data, and/or determined based on a statistical method.

Example 4: The computer system (100, 300) of any preceding example, wherein the processing circuitry (302) is configured to simulate performance of the vehicle (10) based on a current operating point of the vehicle (10).

Example 5: The computer system (100, 300) of any preceding example, wherein the processing circuitry (302) is configured to: simulate performance of the vehicle (10) based on a plurality of operating points of the vehicle (10); and store the determined total costs in a computer storage system of the vehicle (10).

Example 6: The computer system (100, 300) of any preceding example, wherein determining a total cost for a vehicle controller (102, 104) comprises determining a cost associated with each simulation for the respective vehicle controller (102, 104), and determining a sum of the determined costs, for example a weighted sum.

Example 7: The computer system (100, 300) of example 6, wherein the cost associated with a simulation is determined based on one or more of longitudinal, lateral, and/or vertical acceleration and/or jerk of the vehicle (10), energy losses of the vehicle (10), a force margin to the friction limit of the tyres of the vehicle (10), a tyre wear value, peak power of the vehicle (10), deviation from a reference path, a yaw rate and/or deviation from a target yaw rate of the vehicle (10), a velocity and/or deviation from a target velocity of the vehicle (10), a roll angle of the vehicle (10), an articulation angle between units of the vehicle (10), and a pitch angle of the vehicle (10).

Example 8: The computer system (100, 300) of any preceding example, wherein the processing circuitry (302) is configured to discard any vehicle controllers (102, 104) having simulation results that are outside of a set of predetermined limits and/or having a cost above a predetermined value.

Example 9: The computer system (100, 300) of any preceding example, wherein the plurality of vehicle controllers (102, 104) comprises an online vehicle controller (102, 104) and one or more offline vehicle controllers (102, 104).

Example 10: The computer system (100, 300) of example 9, wherein the processing circuitry (302) is configured to simulate performance of the vehicle (10) based on one or more switching methods from the online controller (102, 104) to each of the one or more offline controllers (102, 104).

Example 11: The computer system (100, 300) of any preceding example, wherein the processing circuitry (302) is configured to select the vehicle controller (102, 104) having the lowest total cost.

Example 12: A vehicle (10) comprising the computer system (100, 300) of any preceding example.

Example 13: A computer-implemented method (200) for determining a vehicle controller (102, 104) for use in control of a vehicle (10), the method (200) comprising: acquiring (202), by processing circuitry (302) of a computer system (100, 300), a plurality of input values for each of one or more input variables (116, 118) for simulating performance of the vehicle (10), wherein the plurality of input values represent an uncertainty in the respective input variable (116, 118); simulating (204), by the processing circuitry (302), performance of the vehicle (10) for each of a plurality of vehicle controllers (102, 104), wherein a respective simulation is performed for each vehicle controller (102, 104) for a plurality of possible combinations of input values; determining (206), by the processing circuitry (302), a total cost for each vehicle controller (102, 104) based on the plurality of simulations performed for the respective vehicle controller (102, 104); and selecting (208), by the processing circuitry (302), a vehicle controller (102, 104) of the plurality of vehicle controllers (102, 104) based on the determined costs.

Example 14: The computer-implemented method (200) of example 13, wherein the plurality of input values for a respective input variable (116, 118) comprises an upper and lower bound for the input variable (116, 118) and/or a distribution of input values.

Example 15: The computer-implemented method (200) of example 13 or 14, wherein the plurality of input values are user-defined, determined based on historical data, and/or determined based on a statistical method.

Example 16: The computer-implemented method (200) of any of examples 13 to 15, comprising simulating (204), by the processing circuitry (302), performance of the vehicle (10) based on a current operating point of the vehicle (10).

Example 17: The computer-implemented method (200) of any of examples 13 to 16, comprising: simulating (204), by the processing circuitry (302), performance of the vehicle (10) based on a plurality of operating points of the vehicle (10); and storing, by the processing circuitry (302), the determined total costs in a computer storage system of the vehicle (10).

Example 18: The computer-implemented method (200) of any of examples 13 to 17, comprising determining (206), by the processing circuitry (302), a cost associated with each simulation for the respective vehicle controller (102, 104), and determining a sum of the determined costs, for example a weighted sum.

Example 19: The computer-implemented method (200) of example 18, comprising determining (206), by the processing circuitry (302), the cost associated with a simulation based on one or more of longitudinal, lateral, and/or vertical acceleration and/or jerk of the vehicle (10), energy losses of the vehicle (10), a force margin to the friction limit of the tyres of the vehicle (10), a tyre wear value, peak power of the vehicle (10), deviation from a reference path, a yaw rate and/or deviation from a target yaw rate of the vehicle (10), a velocity and/or deviation from a target velocity of the vehicle (10), a roll angle of the vehicle (10), an articulation angle between units of the vehicle (10), and a pitch angle of the vehicle (10).

Example 20: The computer-implemented method (200) of any of examples 13 to 19, comprising discarding, by the processing circuitry (302), any vehicle controllers (102, 104) having simulation results that are outside of a set of predetermined limits and/or having a cost above a predetermined value.

Example 21: The computer-implemented method (200) of any of examples 13 to 20, wherein the plurality of vehicle controllers (102, 104) comprises an online vehicle controller (102, 104) and one or more offline vehicle controllers (102, 104).

Example 22: The computer-implemented method (200) of example 21, comprising simulating (204), by the processing circuitry (302), performance of the vehicle (10) based on one or more switching methods from the online controller (102, 104) to each of the one or more offline controllers (102, 104).

Example 23: The computer-implemented method (200) of any of examples 13 to 22, comprising selecting (208), by the processing circuitry (302), the vehicle controller (102, 104) having the lowest total cost.

Example 24: A computer program product comprising program code for performing, when executed by processing circuitry (302), the computer-implemented method (200) of any of examples 13 to 23.

Example 25: A non-transitory computer-readable storage medium comprising instructions, which when executed by processing circuitry (302), cause the processing circuitry to perform the computer-implemented method (200) of any of examples 13 to 23.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

What is claimed is:

1. A computer system for selecting a vehicle controller for use in control of a vehicle, the computer system comprising processing circuitry configured to:
acquire a plurality of input values for each of one or more input variables for simulating performance of the vehicle, wherein the plurality of input values represent an uncertainty in the respective input variable;
simulate performance of the vehicle for each of a plurality of vehicle controllers, wherein a respective simulation is performed for each vehicle controller for each of a plurality of combinations of input values;
determine a total cost for each vehicle controller based on the plurality of simulations performed for the respective vehicle controller; and
select a vehicle controller from the plurality of vehicle controllers based on the determined costs.

2. The computer system of claim 1, wherein the plurality of input values for a respective input variable comprises an upper and lower bound for the input variable and/or a distribution of input values.

3. The computer system of claim 1, wherein the plurality of input values are user-defined, determined based on historical data, and/or determined based on a statistical method.

4. The computer system of claim 1, wherein the processing circuitry is configured to simulate performance of the vehicle based on a current operating point of the vehicle.

5. The computer system of claim 1, wherein the processing circuitry is configured to:
simulate performance of the vehicle based on a plurality of operating points of the vehicle; and
store the determined total costs in a computer storage system of the vehicle.

6. The computer system of claim 1, wherein determining a total cost for a vehicle controller comprises determining a cost associated with each simulation for the respective vehicle controller, and determining a sum of the determined costs.

7. The computer system of claim 6, wherein the cost associated with a simulation is determined based on one or more of longitudinal, lateral, and/or vertical acceleration and/or jerk of the vehicle, energy losses of the vehicle, a force margin to the friction limit of the tyres of the vehicle, a tyre wear value, peak power of the vehicle, deviation from a reference path, a yaw rate and/or deviation from a target yaw rate of the vehicle, a velocity and/or deviation from a target velocity of the vehicle, a roll angle of the vehicle, an articulation angle between units of the vehicle, and a pitch angle of the vehicle.

8. The computer system of claim 1, wherein the processing circuitry is configured to discard any vehicle controllers having simulation results that are outside of a set of predetermined limits and/or having a cost above a predetermined value.

9. The computer system of claim 1, wherein the plurality of vehicle controllers comprises an online vehicle controller and one or more offline vehicle controllers.

10. The computer system of claim 9, wherein the processing circuitry is configured to simulate performance of the vehicle based on one or more switching methods from the online controller to each of the one or more offline controllers.

11. The computer system of claim 1, wherein the processing circuitry is configured to select the vehicle controller having the lowest total cost.

12. A vehicle comprising the computer system of claim 1.

13. A computer-implemented method for determining a vehicle controller for use in control of a vehicle, the method comprising:
acquiring, by processing circuitry of a computer system, a plurality of input values for each of one or more input variables for simulating performance of the vehicle, wherein the plurality of input values represent an uncertainty in the respective input variable;
simulating, by the processing circuitry, performance of the vehicle for each of a plurality of vehicle controllers, wherein a respective simulation is performed for each vehicle controller for a plurality of possible combinations of input values;
determining, by the processing circuitry, a total cost for each vehicle controller based on the plurality of simulations performed for the respective vehicle controller; and
selecting, by the processing circuitry, a vehicle controller of the plurality of vehicle controllers based on the determined costs.

14. The computer-implemented method of claim 13, wherein the plurality of input values for a respective input variable comprises an upper and lower bound for the input variable and/or a distribution of input values.

15. The computer-implemented method of claim 13, comprising: simulating, by the processing circuitry, performance of the vehicle based on a plurality of operating points of the vehicle; and storing, by the processing circuitry, the determined total costs in a computer storage system of the vehicle.

16. The computer-implemented method of claim 13, comprising determining, by the processing circuitry, a cost associated with each simulation for the respective vehicle controller, and determining a sum of the determined costs, for example a weighted sum.

17. The computer-implemented method of claim 16, comprising determining, by the processing circuitry, the cost associated with a simulation based on one or more of longitudinal, lateral, and/or vertical acceleration and/or jerk of the vehicle, energy losses of the vehicle, a force margin to the friction limit of the tyres of the vehicle, a tyre wear value, peak power of the vehicle, deviation from a reference path, a yaw rate and/or deviation from a target yaw rate of the vehicle, a velocity and/or deviation from a target velocity of the vehicle, a roll angle of the vehicle, an articulation angle between units of the vehicle, and a pitch angle of the vehicle.

18. The computer-implemented method of claim 13, comprising selecting, by the processing circuitry, the vehicle controller having the lowest total cost.

19. A computer program product comprising program code for performing, when executed by processing circuitry, the computer-implemented method of claim 13.

20. A non-transitory computer-readable storage medium comprising instructions, which when executed by processing circuitry, cause the processing circuitry to perform the computer-implemented method of claim 13.
